(19) United States
(12) Patent Application Publication
(10) Pub. No.: US 2019/0289947 A1
(43) Pub. Date: Sep. 26, 2019

(54) HEAD COVERING AND METHOD

(71) Applicants: Jessie Ricardo Baylor, Ponchatoula, LA (US); Tanya Delores Baylor, Ponchatoula, LA (US)

(72) Inventors: Jessie Ricardo Baylor, Ponchatoula, LA (US); Tanya Delores Baylor, Ponchatoula, LA (US)

(21) Appl. No.: 15/936,384

(22) Filed: Mar. 26, 2018

(51) Int. Cl. A42B 1/04

(52) U.S. Cl. CPC A42B 1/041; B32B 2307/726

(57) ABSTRACT

A durag is provided. The durag includes a center cap portion. The center cap portion is configured to cover a head of a user. The durag further includes a pair of tails. Each of the tails extends away from a peripheral end of the center cap portion. The center cap portion is configured to be sufficiently porous such that water may flow through the center cap portion of the durag to rinse shampoo out of the hair of the user. The durag is configured to enable a fast recovery of the waves created in the hair of the user after the hair is rinsed with the durag on the head of the user.

### FIELD

This application relates to a head covering and method.

### BACKGROUND

A durag (also spelled as doo-rag, dew-rag, or du-rag), is a type of head covering. Durags are regularly used to create and maintain waves and cornrowed hairstyles. Such hairwaves are a popular hairstyle that includes curls that have been laid down. The hair is cropped short to the head in the styling of a caesar cut. After that is done, brushing techniques are then applied to produce an effect reminiscent of “oceanic waves”. Hairwaves can be maintained through frequent and adequate brushing of the hair and the use of a durag. A durag may also be used to hold chemically processed hair-do or hair styles of a user in place, especially whiles the user sleeps. Durags are good for use on natural and chemically processed hair, and help chemically processed hair. Durags usually have long tails on either side that are wrapped around the head to secure the durag by tying them at the back of the head. Durags may also be tied at the front of the head. Durags may be made of nylon material or a polyester material. When washing the hair, one has to remove the durag, wash and rinse the hair, and then put the durag back on. This can be cumbersome and time consuming. Also, the rinsing may cause the waves to deteriorate and lose their form.

Durags may benefit from improvements.

### SUMMARY

In one aspect of the present invention, a durag is provided. The durag includes a center cap portion. The center cap portion is configured to cover a head of a user. The durag further includes a pair of tails. Each of the tails extends away from a peripheral end of the center cap portion. The center cap portion is configured to be sufficiently porous such that water may flow through the center cap portion of the durag to rinse shampoo out of the hair of the user. The durag is configured to enable a fast recovery of the waves created in the hair of the user after the hair is rinsed with the durag on the head of the user.

In another aspect of the present invention, a method is provided. The method includes a) applying shampoo to the hair of a user; b) placing a durag over the shampooed hair; c) rinsing the hair with water with the durag on the head; and d) drying the hair with the durag on the head.

Other aspects of the disclosed invention will become apparent from the following detailed description, the accompanying drawings and the appended claims.

### BRIEF DESCRIPTION OF THE DRAWINGS

FIG. 1 is a top and front perspective view of the durag according to an embodiment of the invention;

FIG. 2 is a bottom and rear perspective view of the durag of FIG. 1;

FIG. 3 is a top and front perspective view of the durag of FIG. 1 being worn on the head of a user;

FIG. 4 is left side perspective view of the durag of FIG. 1 being worn on the head of a user while the hair is being rinsed; and

FIG. 5 is a flow diagram of a method for washing and waving the hair using the durag of FIG. 1.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

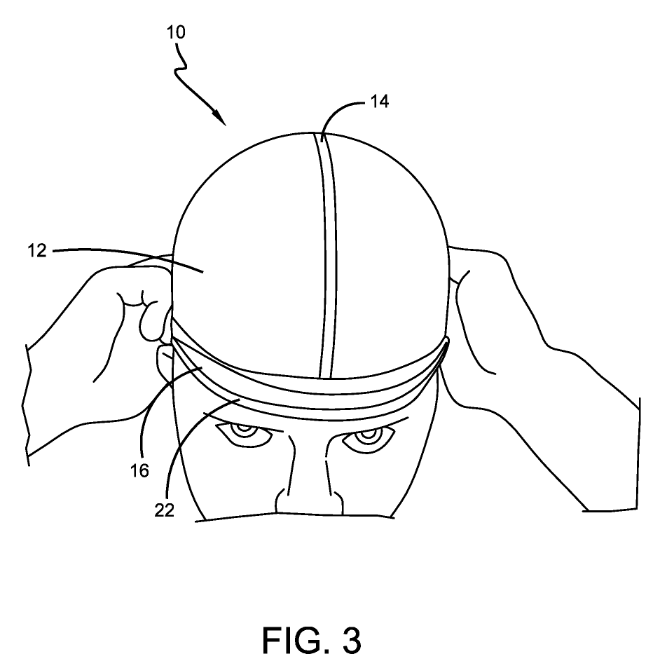

Throughout the present description, the terms “upper”, “lower”, “top”, “bottom”, “left”, “right”, “front”, “forward”, “rear”, and “rearward” shall define directions or orientations with respect to the durag as illustrated in FIG. 3. It will be understood that the spatially relative terms “upper”, “lower”, “top”, “bottom”, “left”, “right”, “front”, “forward”, “rear”, and “rearward” are intended to encompass different orientations of the durag in use or operation in addition to the orientation depicted in the figures. For example, if the durag in the figures is turned over, elements described as “upper” elements or features would then be “lower” elements or features.

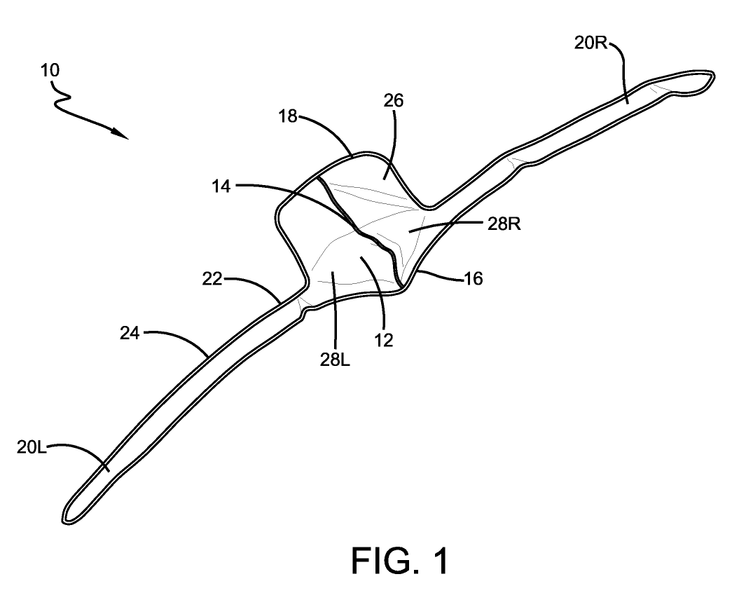

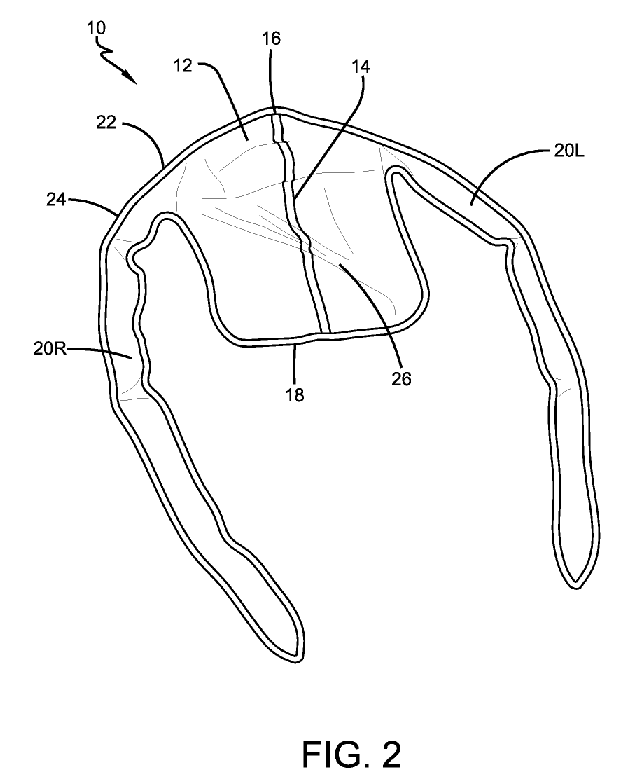

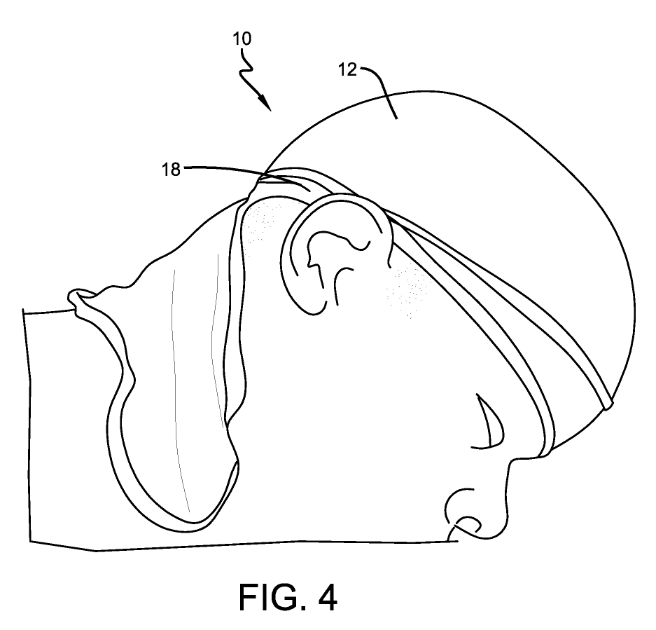

Referring to FIGS. 1 and 2, a durag 10 is shown. The durag 10 includes a hemispherical shaped center cap portion 12 that is configured for covering the entire surface of a head of a user. When placed on a user's head as shown in FIGS. 3 and 4, the center cap portion 12 extends from the front of the user's head to the nape of the neck in the back of the head. A seam 14 is sewn or stitched in the center of the center cap portion 12 and extends from a front end 16 to a rear end 18 of the durag 10 to provide additional strength to the center cap portion 12. The durag 10 further comprise a pair of tying straps or tails 20R, 20L that extend downwardly (as viewed in FIGS. 3 and 4) from the rear end 18 of the center cap portion 12. The length of each tail 20 is more than twice the length of the center cap portion 12. A fabric strip 22 is provided along the peripheral end 24 of the durag 10 and may extend along the entire the peripheral end 24. The fabric strip 22 is of a different color than the remaining inner portion 26 of the durag 10. For example, the peripheral fabric strip 22 may be of white color and the inner portion 26 of the durag may be black. Other example color combinations may comprise a gold peripheral fabric strip and a black inner portion, a black peripheral fabric strip and a white inner portion, a black peripheral fabric strip and a gold inner portion, a blue peripheral fabric strip and a black inner portion. There may be more different color combinations. Alternatively, the peripheral fabric strip and the inner portion may be the same color such as all black or all white.

The durag 10 is made of a thick fabric material. The durag 10 may include an elastic material that enables the durag 10 to stretch. The material may be polyester. The durag 10 is configured to be sufficiently porous such that water from a standard shower head may flow through the center cap portion 12 of the durag 10 to rinse all or most of the shampoo out of the hair of a user yet still allow a fast recovery of the waves created in the hair of the user.

In another embodiment, the durag 10 may also have a two toned color design in which one of the hemispheres 28 of the central cap portion 12 and one of the tails 20 is one color and the other hemisphere of the central cap portion 12, and the other tail is a different color. For example, the left hemisphere 28L of the central cap portion 12 and the left tail 20L may be colored white, and the right hemisphere 28R of the central cap portion 12 and the right tail 20R may be color black. The durag 10 may also alternatively be made of silk.

As illustrated in FIGS. 3 and 4, to wear the durag 10, first the center cap portion 12 is placed on the user's head. Then, the tails 20 are grasped by the user and pulled forward. The tails 20 are then crossed over each other and wrapped around the user's head. The ends of the tails 20 are then tied together at the back of the head.

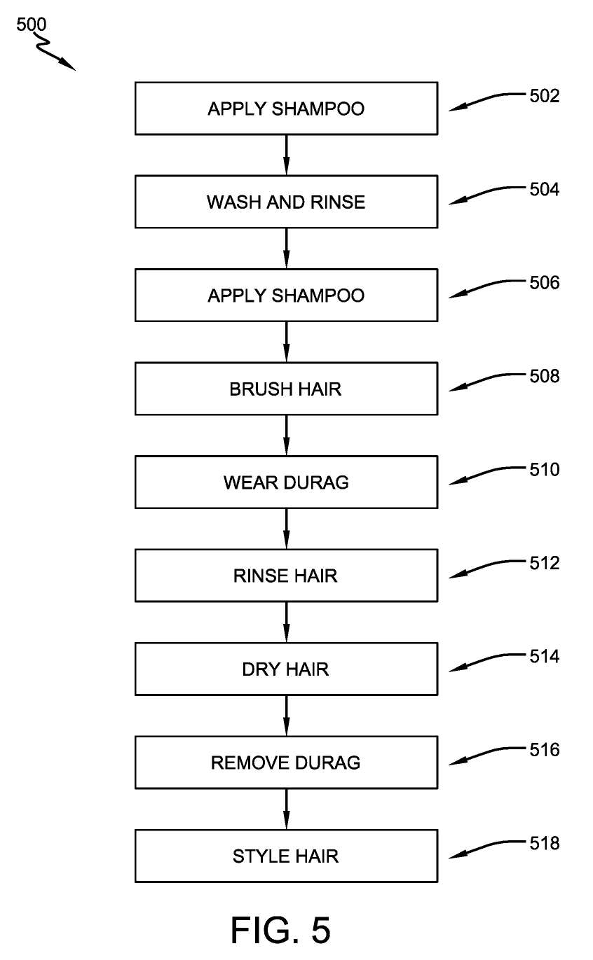

FIG. 5 illustrates a method for washing and waving the hair using the durag 10. In step 502, shampoo is applied until a rich lather is reached. In step 504, the hair is scrambled wash and deep cleaned for 5-10 minutes and rinsed. In step 506, more shampoo is then reapplied until a rich lather is reached. In step 508, with the shampoo still in the hair, the hair is then brushed in a desired wave pattern. In step 510, the durag 10 is then worn on the user. This step includes placing the center cap portion 12 of the durag 10 on the head over the shampooed hair, grasping and pulling the tails 20 forward, crossing the tails 20 over each other, wrapping the tails 20 around the head, and tying the ends of the tails 20 together at the back of the head.

In step 512, with the durag 10 on the head, water from a shower head is sprayed on the center cap portion 12 of the durag 10 to rinse the hair with water for about 10 minutes until all or most of the shampoo is out of the hair as illustrated in FIG. 418. The head may be turned periodically during the rinsing. The washing and rinsing of the hair can done in the shower or sink. Then, in step 514, with the durag 10 still on the head of the user, the hair is dried. The drying of the air may be performed using a blow dryer to expedite the drying process. In step 516, after the hair is dried, the durag 10 is removed and the hair is allowed to decompress for 5-10 minutes. Then, in step 518, the hair can be styled as desired. The use of this durag 10 in accordance with the present invention allows a user to recover the waves back faster after washing the hair and can be done with or without the use of a wave cream. The durag 10 of the present invention allows the rinsing and drying of your hair while wearing it after washing and brushing the hair in the desired wave pattern.

Although various embodiments of the disclosed head covering and method have been shown and described, modifications may occur to those skilled in the art upon reading the specification. The present application includes such modifications and is limited only by the scope of the claims.

What is claimed is:

1. A durag comprising:
a center cap portion, wherein the center cap portion is configured to cover a head of a user;
a pair of tails, wherein each of the tails extends away from a peripheral end of the center cap portion; and
wherein the center cap portion is configured to be sufficiently porous such that water may flow through the center cap portion of the durag to rinse shampoo out of the hair of the user, wherein the durag is configured to enable a fast recovery of the waves created in the hair of the user after the hair is rinsed with the durag on the head of the user.

2. The durag of claim 1, wherein each of the tails has a length that is more than twice the length of the center cap portion.

3. The durag of claim 1 further comprising an elastic material that enables the durag to stretch.

4. The durag of claim 1 further comprising:
an inner portion;
a peripheral end; wherein the peripheral end surrounds the inner portion; and
a fabric strip, wherein the fabric strip extends along the peripheral end, wherein the fabric strip is a different color than the inner portion.

5. The durag of claim 3 further comprising a polyester material.

6. A method comprising:
a) applying shampoo to the hair of a user;
b) placing a durag over the shampooed hair;
c) rinsing the hair with water with the durag on the head; and
d) drying the hair with the durag on the head;

7. The method of claim 6 further comprising brushing the shampooed hair in a desired wave pattern prior to placing the durag over the shampooed hair.

8. The method of claim 7 further comprising removing the durag after the hair is dried.

9. The method of claim 6, wherein drying the hair may be preformed by a hair dryer;

10. The method of claim 6, further comprising removing the durag after the hair is dried.

11. The method of claim 6, wherein the durag comprises:
a center cap portion, wherein the center cap portion is configured to cover a head of a user;
a pair of tails, wherein each of the tails extends away from a peripheral end of the center cap portion; and
wherein the center cap portion is configured to be sufficiently porous such that water may flow through the center cap portion of the durag to rinse shampoo out of the hair of the user, wherein the durag is configured to enable a fast recovery of the waves created in the hair of the user after the hair is rinsed with the durag on the head of the user.
